(19) United States
(12) Patent Application Publication
(10) Pub. No.: US 2012/0219353 A1
(43) Pub. Date: Aug. 30, 2012

(54) JOINT HAVING A BALL HEAD FASTENED TO A PIN AND PLAIN-BEARING FILM FOR SUCH A JOINT

(76) Inventors: Bernd Schaffhaeuser, Fluorn-Winzeln (DE); Rainer Harter, Schenkenzell (DE)

(21) Appl. No.: 13/497,013

(22) PCT Filed: Jul. 28, 2010
(86) PCT No.: PCT/EP2010/004606

§ 371 Date: May 9, 2012

(30) Foreign Application Priority Data
Sep. 18, 2009 (DE) 10 2009 041 807.5

(51) Int. Cl. F16C 11/06; F16C 33/04

(52) U.S. Cl. 403/135

(57) ABSTRACT

A supporting joint includes a ball pin connected to a ball head that is movably mounted in an outer body having a recess, and a sliding element arranged between the ball head and the outer body. The sliding element includes a flexible, disk-shaped plain-bearing film having a plurality of plain-bearing film strips. The strips are arranged relative to each other at least approximately in a star shape. The strips are formed integrally with each other, and separated by slits. The plain-bearing film is placed between the outer body and the ball head in a cup shape such that edges of the plain-bearing film strips lie tightly against each other without overlaps and/or folds.

### PRIORITY INFORMATION

This patent application claims priority from PCT Application No. PCT/EP 2010/004606 filed Jul. 28, 2010 and German Application No. 10 2009 041 807.5 filed Sep. 18, 2009, each of which is hereby incorporated by reference in its entirety.

### BACKGROUND OF THE INVENTION

The present invention relates generally to a joint and, more particularly, to a supporting joint and/or ball and socket joint with a plain bearing film.

Various supporting joints and/or ball and socket joints for steering mechanisms in motor vehicles are known in the art. An example of a ball and socket joint is described in D.E. Application No. 10 2007 016 713, which includes a spherical rod end (also referred to as a ball head) and a spherical pivotal bearing. The pivotal bearing includes a multi-layer plain-bearing shell which is split in two. The plain-bearing shell includes an inner sliding layer of polytetrafluoroethylene (PTFE) that is stuck to a load-bearing layer such as, for example, a steel mesh. The steel mesh is applied to an elastic layer containing an elastomer by means of an adhesion promoting layer. Such a pivotal bearing may be operated without the addition of a lubricant and has improved absorption quality due to the application of the elastic layer. The ball head is enclosed by a total of two stable plain-bearing shell components; i.e., a lower hemispherical first plain-bearing shell component and a ring-shaped second plain-bearing shell component situated above the first plain-bearing shell component. The second plain-bearing shell component must be slid over the ball pin by assembly of the pivotal bearing, which is costly.

Another example of a pivotal bearing is described in D.E. Application No. 10 2008 003 730, which includes a spherical inner body that is encompassed by two housing half shells outside. Each of the two housing half shells is furnished inside with a plain-bearing film.

The pivotal bearings are manufactured as described above so that a specially designed plain-bearing film is applied to the interior of the unformed housing components with, for example, adhesive. The housing components are subsequently cold formed so that the components adapt to the surface of the spherical inner body and are converted to the housing half shells.

### SUMMARY OF THE INVENTION

The object of the present invention is to provide a supporting joint that may accommodate relatively high loads, and a relatively stiff bearing.

According to an aspect of the invention, a joint is provided that includes a pin connected to a ball head that is movably mounted in an outer body having a recess, and a sliding element made from a flexible plain-bearing film arranged between the ball head and the outer body. The plain-bearing film includes a plurality of plain-bearing film strips arranged relative to each other at least approximately in a star shape. The strips are formed integrally with each other and are separated by slits. The plain-bearing film is placed between the outer body and the ball head such that edges of the plain-bearing film strips lie as tightly as possible against each other without, for example, overlaps and/or folds.

The joint may be configured as a supporting joint and/or a ball joint. In some embodiments, therefore, the pin may be a ball pin, tapered pin, cylinder pin or lug.

The joint may include a single, one-piece plain-bearing film. In addition, the joint may have a relatively high stiffness, and may be included in performance handling systems of motor vehicles.

The joint may have a high transmittable axial and radial load capacity. The joint has a low friction coefficient, a small installation space and a light weight. The joint also has a relatively high operating temperature range.

In some embodiments, the plain-bearing film is constructed from Nordglide™ M material, which is made by Saint-Gobain Performance Plastics Pampus GmbH in D-47877 Willich, Germany. Such a plain-bearing film may provide a relatively maintenance-free bearing film with a high load capacity made of a metallic mesh and hard-wearing PTFE compound. Such a plain-bearing film includes a plain-bearing material made out of a PTFE compound which is sintered to a flexible metallic mesh ridge. The PTFE compound may include thirty percent (30%) filler content, where the filler includes fiber glass and/or graphite. The metallic mesh may be a stainless steel mesh made of wire that may be connected to the intersections. Such a plain-bearing film may have a total thickness of, for example, 0.5 mm.

In some embodiments, the plain-bearing film may be inserted in the joint without additional lubricant(s). In other embodiments, the joint includes a lubricant.

In some embodiments, the sated plain-bearing film with its individual plain-bearing film strips fits around the ball head in a spherical shell shape more than a hemispherical shell shape. The plain-bearing film with its plain-bearing film strips may enclose the ball head—starting at the deepest point of the ball head axially—for more than half of the diameter of the ball head; e.g., up to approximately ⅔ of the diameter of the ball head. Thus, the plain-bearing film may almost completely cover the ball head to provide an optimal plain-bearing of the ball head in the outer body. The individual plain-bearing film strips duly lie next to each other as seamlessly as possible.

In some embodiments, the outer body of the joint includes a housing and/or a bearing shell. An at least hemispherical recess for receiving the ball head and a ring-shaped, additional recess for receiving the ring-shaped bearing shell situated above the hemispherical recess are provided in the housing.

In some embodiments, a ring-shaped lug is provided either in the outer body and/or the bearing shell, if the latter is used, as an axial limit for the plain-bearing film

In some embodiments, in order to protect the supporting joint, a ring nut may be screwed to the bearing shell using a thread in the outer body and/or the housing. An axial protection of the whole supporting joint is thereby provided.

In some embodiments, the slits which runs from the radial exterior to the radial interior on a center of the plain-bearing film, if the flexible plain-bearing film is stretched flat, are designed to be tapered from the outside to the inside; e.g., at least approximately triangular. As a result, it has proved favorable to curve the individual plain-bearing film strips viewed in a radial direction to the outside and then to arrange them in a tapered form. It should be ensured that, with the spherical shell-shaped coverings of the ball head, the individual plain-bearing film strips lie as close to each other as possible so that only very small gaps are left, or ideally, so that no gaps remain at all. The plain-bearing film should be substantially without folds and/or overlaps on the ball head.

In some embodiments, the plain-bearing film includes a central opening having a round geometry. Such a central opening significantly eases the operation of the plain-bearing film during assembly, since a device can grip this opening and then hold the plain-bearing film in place.

In some embodiments, the plain-bearing film may include a sintered compound with PTFE or a sintered PTFE compound. For this purpose, a PTFE compound is sintered to a metallic mesh ridge. With the assembly of such a plain-bearing film in the recess of the outer body, then of the housing of the supporting joint, the PTFE layer faces the ball head, while the metallic mesh points towards the housing and/or the outer body.

In some embodiments, the contour of the plain-bearing film may be manufactured as a simple pressed part with individual, one-piece plain-bearing film strips facing each other, where the strips are separated from each other by slits. The special outer contour of the plain-bearing film may, however, also be separated from a continuous plain-bearing film strip in some other way, e.g. by cutting it out.

In some embodiments, the plain-bearing film inserted in the joint is equipped with an upper flange that is formed by the respective free ends of the plain-bearing film strips. The flange is arranged such that it runs at the same height from the lowest point of the ball head. Thus, the upper flange of the plain-bearing film runs in a straight line when mounted. The upper flange may be fastened safely to the aforementioned lug to provide an optimal accommodation of the plain-bearing film.

These and other objects, features and advantages of the present invention will become more apparent in light of the following detailed description of preferred embodiments thereof, as illustrated in the accompanying drawings.

### BRIEF DESCRIPTION OF THE DRAWING

In the following diagrams, unless otherwise indicated, identical reference characters always designate identical parts with the same meaning.

FIG. 1 is a cross-sectional illustration of a supporting joint with a ball pin and a ball head orientated towards a longitudinal axis of the supporting joint;

FIG. 1A is an enlarged illustration of section A of the supporting joint of FIG. 1;

FIG. 2 is a cross-sectional illustration of the supporting joint of FIG. 1 with a slanted ball pin;

FIG. 3 is an illustration of a plain-bearing film in a stretched-out flat configuration;

FIG. 4 is an enlarged illustration of a strip B of the plain-bearing film of FIG. 3;

FIG. 5 is a perspective illustration of the plain-bearing film of FIG. 3 in a curved configuration;

FIG. 6 is a partial cutaway illustration of another supporting joint with a plain-bearing film;

FIG. 7 is a partial cutaway illustration of still another supporting joint;

FIG. 8 is a partial cutaway illustration of still another supporting joint;

FIG. 9 is an illustration of another plain-bearing film in a stretched-out flat configuration;

FIG. 10 a perspective illustration of the plain-bearing film of FIG. 9 in a curved configuration;

FIG. 11 is an illustration of still another plain-bearing film in a stretched-out flat configuration; and

FIG. 12 is a perspective illustration of the plain-bearing film of FIG. 11 in a curved configuration.

### DETAILED DESCRIPTION OF THE INVENTION

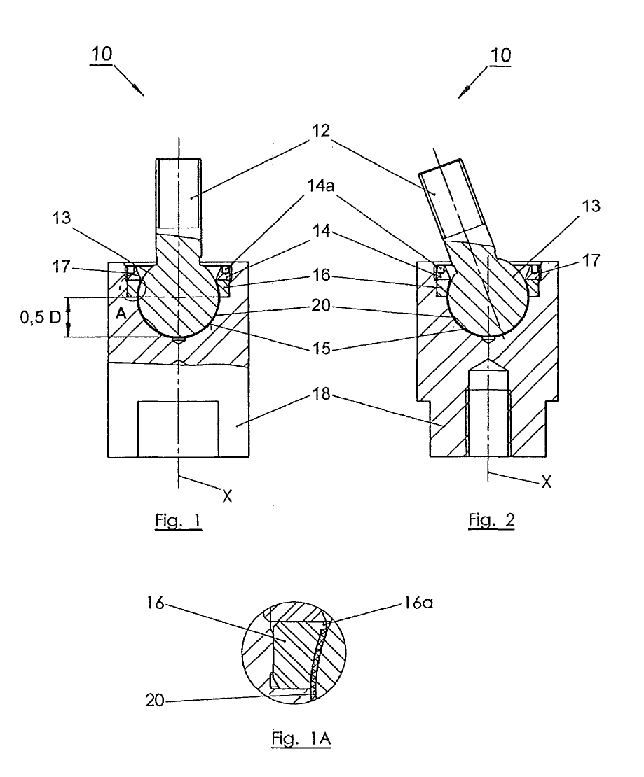

FIG. 1 illustrates a first embodiment of a supporting joint 10. The supporting joint 10 includes a ball pin 12, in a lower end of which a ball head 13 is mounted. The ball pin 12 of FIG. 1 is illustrated with the ball head 13 orientated on an X-axis of the supporting joint 10. The ball head 13 sits in a hemispherical shell-shaped recess 15 of a housing 18. Above the hemispherical shell-shaped recess 15 of the housing 18 is a ring-shaped bearing shell 16. The inner diameter of the ring-shaped bearing shell 16 is adapted to the ball contour of the ball head 13, and has a slightly larger diameter than an outer diameter of the ball head 13. The hemispherical shell-shaped recess 15 of the housing 18 also is adapted to the ball contour of the ball head 13, and has a slightly larger diameter than the outer diameter of the ball head 13.

A plain-bearing film 20 is arranged between the ball head 13 and the hemispherical shell-shaped recess 15 of the housing 18 and the inner wall of the ring-shaped bearing shell 16. The plain-bearing film 20 is cup-shaped and/or partially spherically shell-shaped in the slit-shaped, spherical opening formed between the ball head 13 and the housing 18 on the one hand and between the inner wall of the ring-shaped bearing shell 16 and the ball head 13 on the other hand.

Referring to FIG. 1A, the plain-bearing film 20 substantially overlaps the lower half of the ball head 13 and adjoins a ring-shaped rotary flange and/or lug 16a of the ring-shaped bearing shell 16. Referring again to FIG. 1, the plain-bearing film 20 overlaps approximately one half of the diameter 0.5 D of the ball head 13 and up to approximately two thirds (⅔) of the diameter D of the ball head 13. An additional ring-shaped opening is provided in the housing 18 above the ring-shaped bearing shell 16. The ring-shaped opening in the housing 18 has a thread 17 in which a ring nut 14 with an outer thread can be screwed. The screwing of the ring nut 14 in the housing 18 secures and braces the ring-shaped bearing shell 16 in the housing. In order to tighten the ring nut 14 in the housing 18, a plurality of holes 14a are disposed in the side of the ring nut 14 facing the ball pin 12, whereby torsion of the ring nut 14 with a suitable tool is possible. In other embodiments, slits, grooves, notches or the like may be used instead of the holes 14a.

FIG. 2 illustrates the supporting joint 10 of FIG. 1 with a ball pin 12 slanted relative to the X-axis.

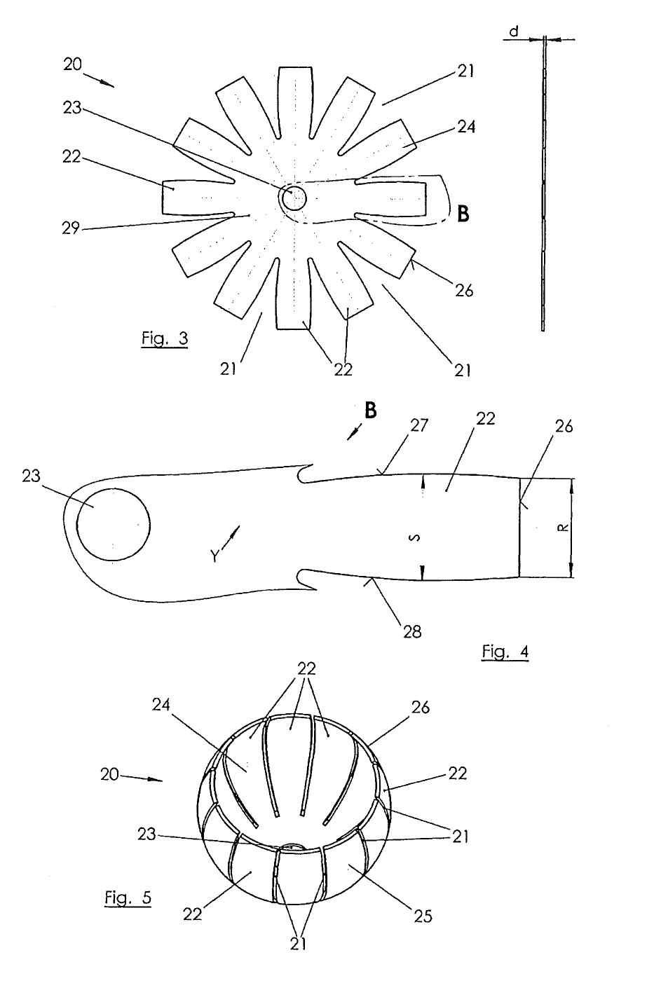

FIG. 3 illustrates the plain-bearing film 20 in a stretched out flat configuration. The plain-bearing film 20 may be made from a flat material made from tape with a view to the plain-bearing film surfaces 24. The plain-bearing film 20 includes a plain-bearing ridge 25 (see FIG. 5), which is turned away from the viewer in FIG. 3. The plain-bearing film 20 has a central opening 23 from which a plurality of plain-bearing film strips 22 extend in a radial direction. Adjacent strips 22 are separated by respective slits 21. A metal mesh made from a PTFE compound underlying the plain-bearing film 20. The side of the plain-bearing film 20 that includes the metal mesh is turned away from the viewer in FIGS. 4 and 5. The metal mesh is arranged on the outer side of the partially spherical shell in FIG. 5. The plain-bearing film 20 is contoured so that whether it is cup-shaped and/or spherically shell-shaped or partially spherically shell-shaped it can be positioned optimally around the ball head 13. An optimal application is understood to be an application of the plain-bearing film 20 on the ball head 13 that is free of overlaps and folds. The plain-bearing film strips 22 are attached to a middle, ring-shaped rotary plain-bearing film component 29. This rotary plain-bearing film component 29 extends from the flange of the opening 23 to the beginning of each slit 21. As illustrated in FIG. 3, the slits 21 extend more or less from the outer flange 26 of each plain-bearing film strip 22 approximately a quarter of the diameter in the direction of the center and/or opening 23. The individual slits 21 have approximately triangular and taper geometries that extend from the flange 26 towards the inner opening 23.

Referring to FIGS. 3 and 4, the individual plain-bearing film strips 22 each have a somewhat bulbous design. A bulbous design is understood to mean that the opposing edges 27, 28—originating from the opening 23—in the center of the plain-bearing strip in FIG. 3 curve outwardly to some extent towards the outer flange 26. The individual plain-bearing film strips 22 in the position marked by the reference character S in FIG. 4 therefore are broader than on the outer flange 26, which has the width R. As additionally outlined, the flange 26 of each plain-bearing film strip 22 is perpendicular to the symmetrical line Y of each plain-bearing film strip 22.

The bulbous contour permits the individual plain-bearing film strips 22 to wrap around the ball head 13 without unnecessarily broad slits 21 remaining as illustrated in FIG. 5. Ideally, the plain-bearing film 20 has relatively small slits 21 or absolutely no slits when it is wrapped around the ball head 13; e.g., the individual plain-bearing film strips 22 may touch each other longitudinally. FIG. 5 illustrates the upper circular rotary flange 26, which on account of the substantially equal lengths of the individual plain-bearing film strips 22 in relation to the lowest point of the ball head 13, is arranged at the same height when mounted correctly. The rotary flange 26 has its lug in the mounting of the plain-bearing film 20 on the ring-shaped rotary lug 16a of the ring-shaped bearing shell 16. A slippage of the plain-bearing film 20 when mounted in the supporting joint 10 is therefore prevented. The plain-bearing film 20 is securely ‘accommodated’ by this lug 16a.

Although it is perfectly possible to add a lubricant to the plain-bearing film 20, it is not necessary. A lubricant-free supporting joint, for example, is presentable with such a contoured plain-bearing film 20.

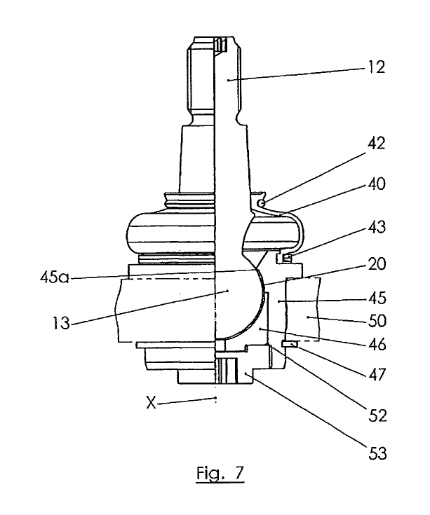

Additional embodiments of a supporting joint 10 are illustrated in FIGS. 7 to 9. All of these embodiments may include a plain-bearing film 20 as illustrated, for example, in FIGS. 4 to 6.

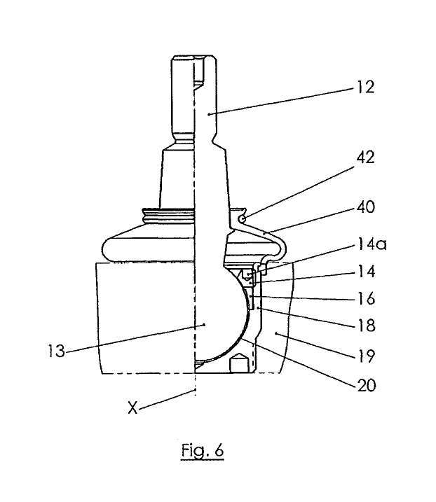

FIG. 6 illustrates the ball pin 12 with a ball head 13 mounted below along the X-axis with half of the represented top view and half of the sectional view. The plain-bearing film 20 is located in turn between the housing 18 and the ball head 13. The upper rotary part of the plain-bearing film 20 is, as illustrated in FIG. 1, located in the ring-shaped bearing shell 16, which is secured from above by a ring nut 14 screwed in the housing 18. Contrary to the embodiment of FIG. 1, the housing 18 is situated in an outer part 19. In addition, the supporting joint 10 is caulked with a sealing gasket 40. The sealing gasket 40 overlaps the lower part of the pin 12 and is secured by a first clamping ring 42. The sealing gasket 40 is attached to the housing 18 by the end facing the ball head 13, for example, by vulcanization or by clamping in a corresponding groove of the housing 18.

Referring to FIG. 7, the ball head 13 is in a bearing shell 46 that includes a hemispherical opening for receiving the ball head 13. The bearing shell 46 is surrounded by a housing 45. The housing 45 has a ring-shaped inner wall that overlaps the upper part of the ball head 13 in a similar manner to the bearing shell 16 of FIG. 6. An inner contour, for example, is adapted to the ball head 13. The housing 45 which, similarly to the bearing shell 16 of FIG. 6, has a ring-shaped rotary lug 45a for the axial security of the plain-bearing film 20.

The housing 45 is mounted in an outer part 50 and secured axially with a locking ring 47. The bearing shell 46 is on a nut 53. An O-ring 52 may be placed between the nut 53 and the bearing shell 46.

The supporting joint in FIG. 7 likewise includes a sealing gasket 40, which is fastened to the ball pin 12 by a first clamping ring 42 above and by a second clamping ring 43 below.

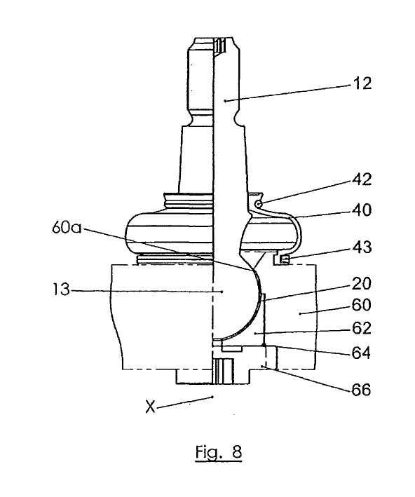

The outer part 60 of the bearing shell 62 of FIG. 8, in contrast to the outer part 50 of FIG. 7, overlaps the ball head 13. The plain-bearing film 20 protrudes into the recess of the bearing shell 62, and overlaps the bearing shell 62 so that the upper end of the plain-bearing film 20 lies between the outer part 60 and the ball head 13. The lug is affected by a ring-shaped lug 60a on the outer part 60 for the axial security of the plain-bearing film 20.

Although the plain-bearing film 20 was represented in connection with FIGS. 3 to 5, other plain-bearing film configurations may also be used where a plurality of plain-bearing film strips 22 extend to a ring-shaped rotary middle plain-bearing film component 29. Preferably, the plain-bearing film 20 should include at least three plain-bearing film strips 22; e.g., between five and twelve plain-bearing film strips.

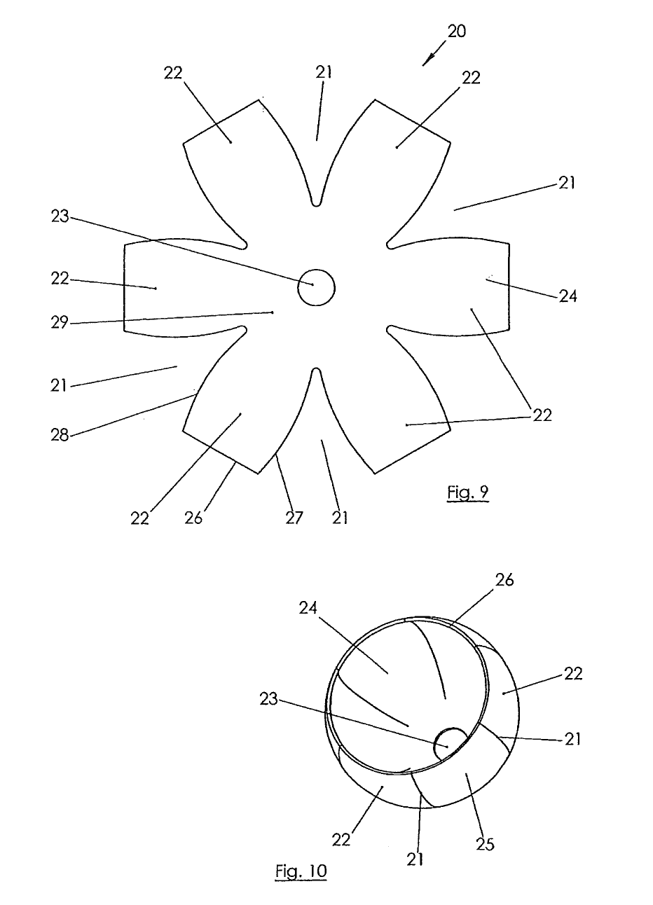

FIGS. 9 and 10 illustrate an alternate embodiment plain-bearing film 20 that includes six plain-bearing film strips 22. The plain-bearing film strips 22 extend in a star shape from the middle opening 23. The slits 21 extend respectively between the individual plain-bearing film strips 22. The reference characters already used in FIGS. 3 to 5 are used again for this embodiment of the plain-bearing film 20. The edges 27, 28 are also arranged originating parallel to each other in this embodiment.

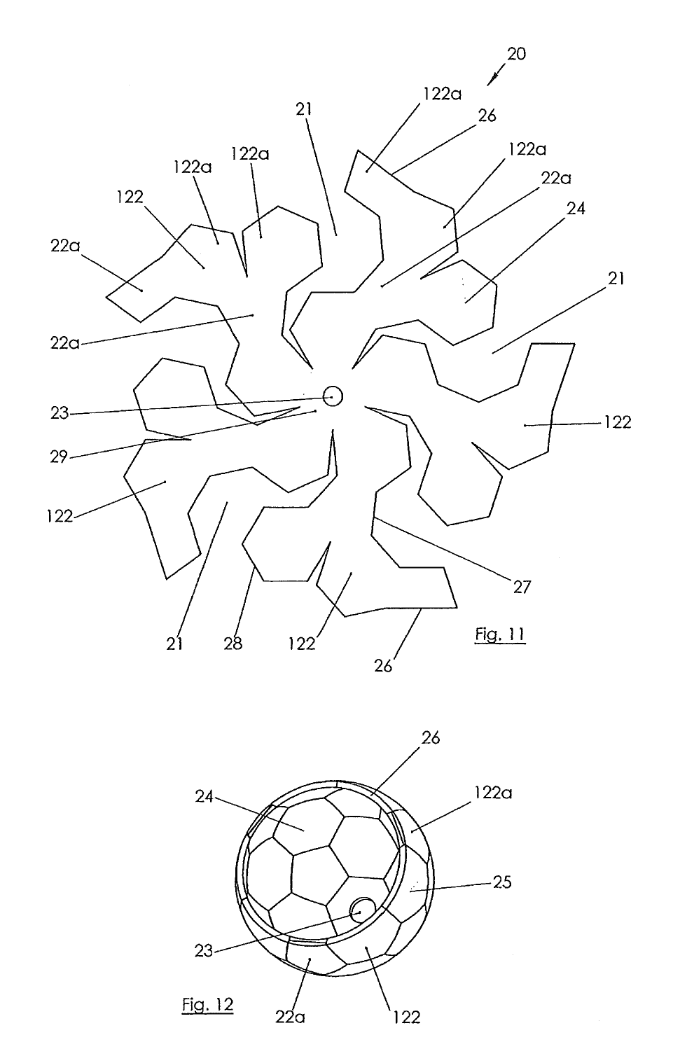

FIGS. 11 and 12 illustrate another alternate embodiment plain-bearing film including a plurality of individual plain-bearing film strips 122. The individual plain-bearing film strips 122 are separated by respective slits 21. The plain-bearing film strips 122 extend in a star-shaped manner and have substantially non-parallel edges 27, 28. The individual plain-bearing film strips 122, for example, are formed by honeycombed sections 122a strung together. The individual sections 122a may join together optimally with the enclosure of the ball head of a joint so that there are no slits, or almost no slits. The advantage of such an arrangement is that an even better enclosure of the ball head of a joint can be achieved.

FIG. 12 illustrates a curved version of the strung-together honeycombed sections 122a of the individual plain-bearing film strips 122, in which a partially spherical shell is formed.

Although the present invention has been illustrated and described with respect to several preferred embodiments thereof, various changes, omissions and additions to the faun and detail thereof, may be made therein, without departing from the spirit and scope of the invention.

What is claimed is:

1. A joint, comprising:
a pin connected to a ball head that is movably mounted in an outer body having a recess; and
a sliding element arranged between the ball head and the outer body, the sliding element comprising a flexible plain-bearing film that includes a plurality of plain-bearing film strips arranged at least approximately in a star shape, formed integrally with each other and separated by slits, wherein the plain-bearing film is placed between the outer body and the ball head in such that edges of the plain-bearing film strips lie against each other without at least one of overlaps and folds;
wherein the outer body includes at least one of a housing and a bearing shell, with a ring-shaped lug configured as an axial limit for the plain-bearing film.

2. The joint of claim 1, wherein the plain-bearing film with the plain-bearing film strips encloses the ball head in one of a partially spherical shape and a cup shape.

3. The joint of claim 1, wherein the plain-bearing film with the plain-bearing film strips overlaps the ball head originating from a deepest point of the ball head axially by more than half of a diameter of the ball head.

4. (canceled)

5. The joint of claim 1, wherein the housing comprises an at least approximately hemispherical recess that receives the ball head, and an additional ring-shaped recess above the hemispherical recess that receives the ring-shaped bearing shell.

6. (canceled)

7. The joint of claim 1, further comprising a ring nut screwed to the bearing shell by a thread in the housing for the axial security of the ball head.

8. The joint of claim 1, wherein the slits taper from the outside to the inside where the plain-bearing film is stretched out flat.

9. The joint of claim 6, wherein each of the individual plain-bearing film strips viewed in a radial direction is curved bulbously towards its outside.

10. The joint of claim 1, wherein the plain-bearing film includes a central opening.

11. The joint of claim 1, wherein the plain-bearing film includes a metal mesh.

12. The joint of claim 9, wherein the side of the plain-bearing film is coated with a PTFE compound that faces the ball head.

13. The joint of claim 1, wherein the plain-bearing film with its slits and its plain-bearing film strips is a pressed part.

14. The joint of claim 1, wherein the plain-bearing film includes an upper rotary flange that runs from a lowest point of the ball head at a similar height to this point.

15. The joint of claim 1, wherein the plain-bearing film sits within the joint without the addition of a lubricant.

16. The joint of claim 1, further comprising a lubricant configured with the plain-bearing film.

17. The joint of claim 1, wherein the plain-bearing film is separated from a flat material.

18. The joint of claim 1, wherein the plain-bearing film includes at least three of the plain-bearing film strips.

19. The joint of claim 1, wherein each of the plain-bearing film strips includes a plurality of edges running at least approximately parallel to each other.

20. The joint of claim 1, wherein each of the plain-bearing film strips is formed from a plurality of honeycombed sections strung together.

21. The joint of claim 1, wherein the slits run radially towards a center of the plain-bearing film when stretched out flat, wherein the plain-bearing film strips are respectively arranged between the slits and are attached to each other as one piece towards the centre.

22. The joint of claim 19, further comprising an opening provided in a center, which is bound by a rotary flange connected to the plain-bearing film strips.
